(19) United States
(12) Patent Application Publication
(10) Pub. No.: US 2009/0144456 A1
(43) Pub. Date: Jun. 4, 2009

(54) Interface Device for Securely Extending Computer Functionality

(76) Inventors: Alexander David Gelf, Campbell, CA (US); Igor Jonatan Schmidt, San Jose, CA (US)

Correspondence Address: CARR & FERRELL LLP, 2200 GENG ROAD, PALO ALTO, CA, 94303, US

(21) Appl. No.: 12/325,188

(22) Filed: Nov. 29, 2008

Related U.S. Application Data
(60) Provisional application No. 61/004,965, filed on Nov. 30, 2007.
(60) Provisional application No. 61/192,943, filed on Sep. 23, 2008.
(60) Provisional application No. 61/134,504, filed on Jul. 10, 2008.
(60) Provisional application No. 61/188,194, filed on Aug. 6, 2008.

(51) Int. Cl. G06F 3/00; G06F 13/00

(52) U.S. Cl. 710/8; 710/305

(57) ABSTRACT

A portable interface device for extending the secure functionality of a computing device includes a plurality of ports and a controller, the ports being configured to facilitate communication between the interface device and one or more computing devices and between the interface device and one or more extension devices. The interface device extends the functionality of one or more computing devices by communicating to the computing device the functionality of one or more extension devices. Extension devices can be chained, and the interface device can emulate the combined functionality of the chained extension devices. A method for extending the functionality of a computing device detects an extension device for the computing device, identifies a functionality of the extension device, and communicates the functionality of the extension device to the computing device.

### CROSS-REFERENCE TO RELATED APPLICATIONS

This application claims benefit of priority to U.S. Provisional Patent Applications No. 61/004,965, filed Nov. 30, 2007, entitled “Modular Multipurpose Attachment for a Computing Device,” U.S. Provisional Patent Applications No. 61/192,943, filed Sep. 22, 2008, entitled “System and Method for Interfacing an Add-On with a Personal Digital Device,” U.S. Provisional Patent Applications No. 61/134,504, filed Jul. 10, 2008, entitled, “System and Method for NFC Payments,” and U.S. Provisional Patent Applications No. 61/188,194, filed Aug. 6, 2008, entitled “Contactless System and Services.” The disclosures of all the above U.S. patent applications are incorporated herein by reference.

### BACKGROUND

Universal Serial Bus (USB) devices typically contain a flash drive to operate as a portable mass storage device. The USB flash drive is able to connect to a computing device having a USB port and provide access to data contained on the device. Typical USB flash drives contain a single USB Port and data that can be retrieved and processed by a device connected to the flash drive. Though USB flash devices are useful in that they are small and portable, the functionality of such devices is limited.

### SUMMARY

The present technology includes a modular and extendable interface device for securely facilitating communication between one or more other devices. Several interface devices can be connected together as modules to form a single compound interface device. The interface device may also connect to one or more extension devices, each of which may extend the functionality of the interface device. The interface device may communicate with the extension devices as well as facilitate cooperative functionality between multiple extension devices. The interface device may also communicate with one or more computing devices, and may allow the computing device to control any extension devices and modular interface devices.

In an embodiment of the present technology, a portable interface device is presented, comprising a) a first communication port configured to facilitate secure communication between the computing device and the portable interface device; b) a second communication port configured to facilitate secure communication between the portable interface device and an extension device; and c) a controller configured to facilitate extended functionality between the computing device and the extension device, whereby the computing device can access functionality of the extension device.

In another embodiment of the present technology, a portable interface device is presented, comprising a) a plurality of ports, each port being configured to facilitate secure communication between the interface device and at least one of one or more computing devices and one or more extension devices; and b) a controller configured to facilitate extended functionality between at least one of the one or more computing devices and at least one of the one or more extension devices, whereby at least one of the one or more computing devices can access functionality of at least one of the one or more extension devices.

In a further embodiment of the present technology, a portable interface device is presented, comprising: a) a plurality of ports, each port being configured to facilitate secure communication between the interface device and at least one of one or more computing devices and one or more extension devices; and b) a controller configured to facilitate extended functionality between at least one of the one or more computing devices and at least one of the one or more extension devices, whereby at least one of the one or more computing devices can access functionality of at least one of the one or more extension devices. In this embodiment, at least one of the plurality of ports is a universal serial bus (USB) port, at least one of the plurality of ports is a Bluetooth port, and at least one port of the plurality of ports is a near field communications (NFC) port.

In yet another embodiment of the technology, a method is presented for extending the secure functionality of a computing device, comprising the steps of a) initializing a portable interface device; b) selecting a computing device; c) selecting an extension device; d) allowing the interface device to configure a first port to facilitate secure communication between the computing device and the portable interface device; e) allowing the interface device to configure a second port to facilitate secure communication between an extension device and the computing device; and f) allowing the portable interface device to facilitate extended functionality between the computing device and the extension device, whereby the computing device can access functionality of the extension device.

In a still further embodiment of the technology, a system is presented for extending the secure functionality of a computing device, comprising: a) a computing device; b) an extension device; c) and a portable interface device, the portable interface device being configured to facilitate secure communication between the computing device and the portable interface device, to facilitate secure communication between the portable interface device and an extension device; and to facilitate extended functionality between the computing device and the extension device, whereby the computing device can access functionality of the extension device.

### BRIEF DESCRIPTION OF THE DRAWINGS

FIG. 1 illustrates a front perspective view of an exemplary interface device.

FIG. 2 illustrates a rear perspective view of an exemplary interface device.

FIG. 3 illustrates a block diagram of an exemplary interface device.

FIG. 4 illustrates a block diagram of an exemplary controller.

FIG. 5 illustrates an example of interconnected interface devices.

FIG. 6 illustrates an example of an interface device connected to extension devices.

FIG. 7 illustrates a flow chart of an exemplary method of operation for an interface device.

FIG. 8 illustrates a flow chart of an exemplary method for facilitating communication by an interface device.

FIG. 9 illustrates a flow chart of an exemplary method for facilitating communication between a wireless extension device and an NFC target.

FIG. 10 illustrates an exemplary system for facilitating communication between a wireless extension device and an NFC target.

FIGS. 11A-B illustrate an exemplary interface device and attachment mechanism for facilitating wireless communication.

### DETAILED DESCRIPTION

The present technology includes a modular and extendable interface device for securely facilitating communication and interoperability among one or more other devices. Several interface devices can be connected together as modules to form a single compound interface device. The interface device may also connect to one or more extension devices, whereby the interface device may utilize and control the functionality of the extension devices. The interface device may also communicate with one or more computing devices, and may allow the computing device to control any extension devices and modular interface devices. Communication facilitated by the interface device can be secured to provide a reliable and safe means for operating multiple extension devices together and/or with one or more other computing devices.

In some embodiments, the interface device is modular in that several interface devices may interconnect to form a compound interface device. When interconnected, the interface devices can communicate with each other and coordinate use of their respective resources. For example, files may be partially stored on memory in two or more connected interface devices, a first extension device connected to a first interface device may communicate with another extension device connected to a second interface device, and so forth. Communication and interoperability among interconnected interface devices are discussed in more detail below

In some embodiments, an interface device can communicate with one or more extension devices. Communication between an interface device and an extension device may occur through a wired connection or a wireless connection. When connected, the interface device may facilitate communication between extension devices as well as with a computing device. For example, an interface device connected to two extension devices may provide input received from a first extension device to a second extension device. Similarly, the interface device may provide control instructions to an extension device based on signals received from another extension device. Communication between an interface device and extension device is discussed in more detail below.

In some embodiments, an interface device can be configured as a wireless payment device. Wireless connection mechanisms in the interface device can be used connect to a mobile device configured for wireless communication, for example a mobile phone enabled to communicate using “Bluetooth” wireless protocol. The interface device may also communicate wirelessly with a Near Field Communication (NFC) target. When connected to a target via NFC protocol and a mobile phone via Bluetooth protocol, the interface device may facilitate communication between the two “extension devices” (the mobile phone and the NFC target). For example, the interface device may perform card emulation, actively or passive read RFID tags, or otherwise operate to allow a user to perform mobile ticketing, mobile payment, interact with “smart posters” or billboards with RFID tags, or other functions for mobile devices not configured with NFC capabilities. Use of the interface device to provide NFC capabilities is discussed in more detail below.

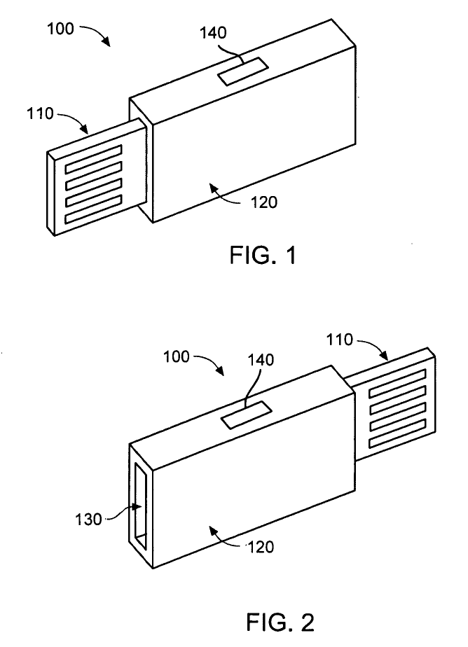

FIG. 1 illustrates a front perspective view of an exemplary interface device 100. Interface device 100 includes plug 110, casing 120, and extension device port 140. Plug 110 may be any plug that is suitable for communicating data. For example, plug 110 may be implemented as a USB A, B, mini-B, micro-B, or micro-AB plug. In some embodiments, interface device may connect to a computing device port using plug 110. Casing 120 contains logic, circuitry, antennas, receptacles/ports and other portions of the interface device. The casing 120 can be composed of metal, plastic, and/or other materials.

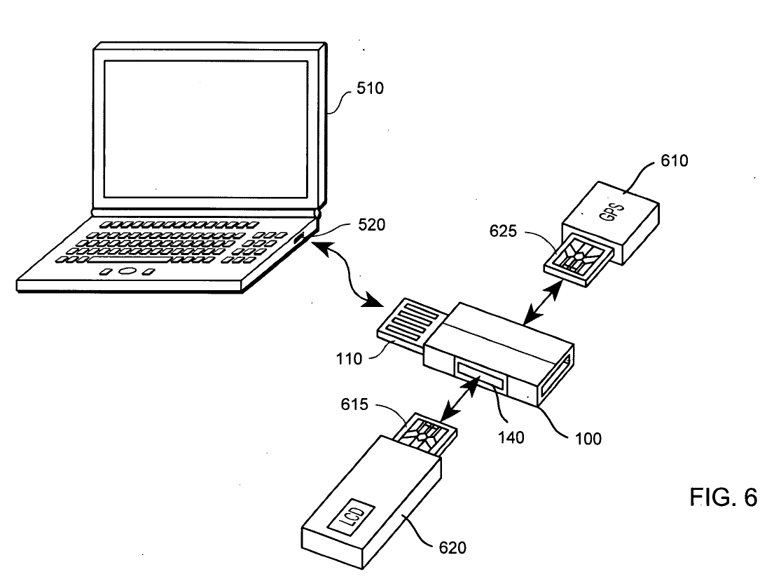

Extension device interface 140 may receive a plug, provide a receptacle, or otherwise enable connection with an extension device. An interface device may contain any number of extension device interfaces, either in plug, receptacle or other form. The logic within the interface device 100 may facilitate communication between extension devices using one or more extension device ports 140. Extension device interface 140 may be compatible with Ethernet, IEEE 1394, PS-2, optical, SubMiniature Version A (SMA), Peripheral Component Interconnect Express (PCI Express), SDCard, SIM card, various audio, video and other media interfaces, as well as other interfaces. Examples of extension devices are discussed in more detail below with respect to FIG. 6.

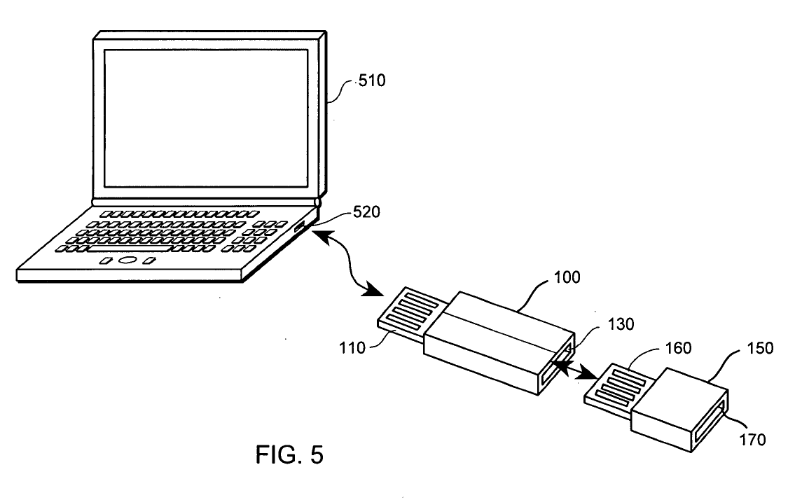

FIG. 2 illustrates a rear perspective view of an exemplary interface device 100. The interface device 100 of FIG. 2 includes plug 110, casing 120, extension device interface 140 and receptacle 130. Receptacle 130 may be suitable for connecting to one or more extension devices or interface devices. When used to establish connection to an interface device, the receptacle may facilitate communication between the interconnected interface devices, for example through a USB interface. Interconnected interface devices are discussed in more detail below with respect to FIG. 5.

The interface device 100 is portable in that it is detachable from a computing device. That is, the interface device is not a hardwire component of the computing device but rather is what a person of skill in the art would consider a separate product from the computing device. As such, the interface device can be attached to and detached from a virtually limitless number of computing devices as many times as may be desired by or convenient for a user. This feature maximizes the utility of the present technology.

In some embodiments, the interface device 100 may be implemented within a casing that is close in size to a typical USB device (though the device has considerably more functionality). For example, the casing generally has a length and a width, wherein the length is greater than the width. For the exemplary device illustrated in FIGS. 1 and 2, the length of the casing extends between plug 110 and receptacle 113. The perimeter of the interface device, as measured along the length of the casing, can have a value of approximately nine (9) inches or less. In some embodiments, the perimeter can be less than eight (8) inches in length. Hence, the casing of the interface device is considerably compact and portable.

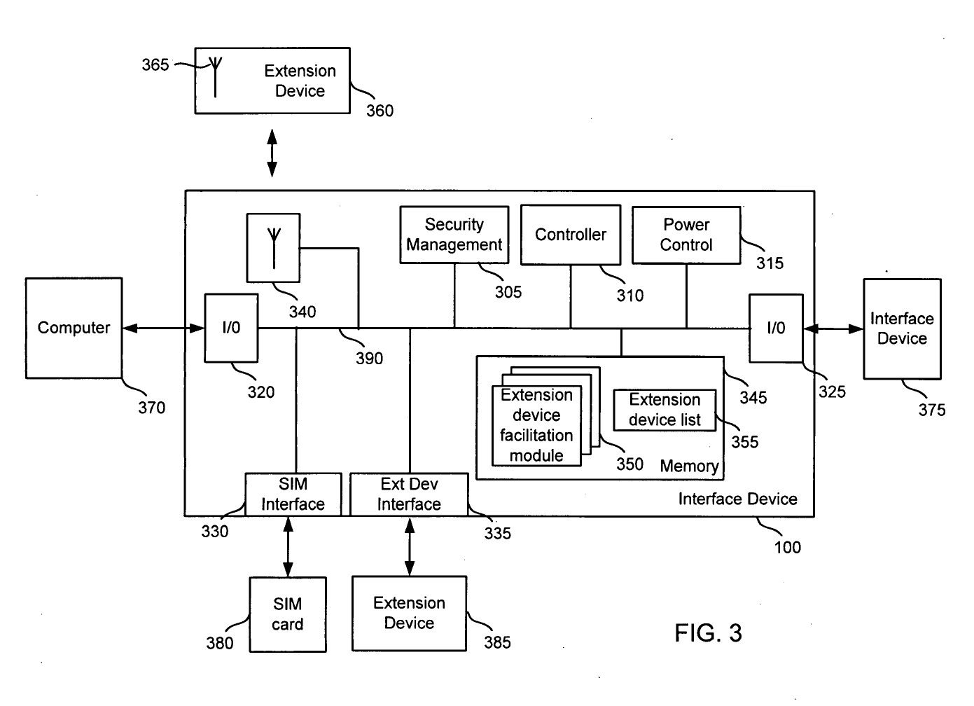

FIG. 3 illustrates a block diagram of an exemplary interface device. Exemplary interface device 100 includes security management 305, controller 310, power control 315, input/output interface 320 and 325, SIM interface 330, extension device interface 335, antenna logic 340, memory 345, and data bus 390. Data bus 390 may be comprised of one data bus or multiple data buses. For example, data bus 390 may include an I/O bus between controller 310 and interfaces 320 and 330, a memory bus between memory 345 and controller 310, and other buses. Each of elements 305-355 within interface device 100 is connected to bus 390.

Security management 305, controller 310, and power control 315 may be implemented using hardware, software, or a combination thereof. Security management 305 may control security functions related to communication of data between different input and output interfaces, both wired and wireless, of interface device 100. For example, security management 305 may determine access and rights to functionality of one or more extension devices, provide encryption and decryption of data, control keys and certification generation and authentication, and other security related functions.

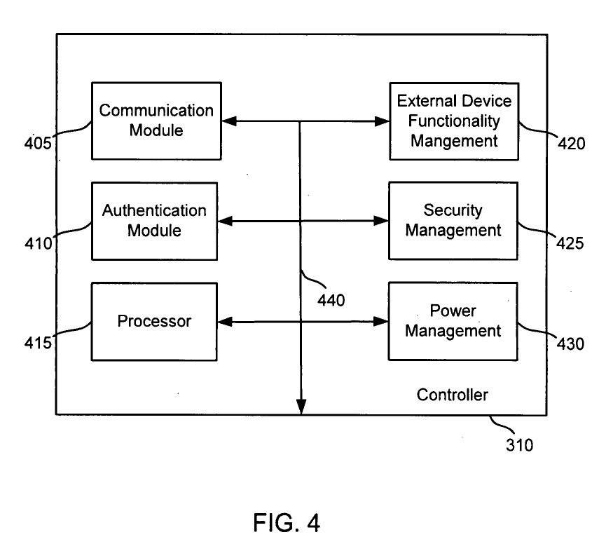

Controller 310 may include hardware and/or software for controlling operation of the interface device. For example, controller 310 may be implemented with one or more processors configured to execute code stored on memory 345. Functionality that can be handled by controller 310 may include authentication, extension device functionality management, power management, and other functions. Controller 310 is discussed in more detail below with respect to FIG. 4.

Power control 315 may control and manage power-related functions of interface device 100. In some embodiments, power control 315 may include circuitry for managing a rechargeable battery (not illustrated in FIG. 3). For example, the power control 315 may include circuitry that enables a rechargeable batter to be recharged upon connection of the interface device 100 to a computing device. Power control 315 may also control providing power to different portions of interface device 100 based on different modes of operation. For example, during a reduced power mode, power control 315 may not provide power to antenna logic 340 or other portions of the interface device.

Input/output (I/O) interface 320 and 325, SIM interface 330, extension device interface 335, and antenna logic 340 allow the interface device 100 to communicate with other systems and devices. For example, I/O interface 320 can be used to connect with a computer 370, for example through a USB interface plug 110, or some other interface. I/O interface 320 can be used to form a connection with another extension device, for example by receptacle 130, thereby forming a compound interface device. SIM interface 330 may receive a subscriber identity module (SIM) card or mini-SIM card 380, and access information from the SIM card 380. The SIM interface 330 may include components such as rails, sleeves, or other mechanisms to secure the SIM card in place as it is accessed by interface device 100.

Extension device interface 335 and antenna logic 340 enable the interface device 100 to communicate with one or more extension devices by wired or wireless connections, respectively. For example, extension device interface 335 may connect to an extension device 385 that utilizes a communications interface for a smart card, subscriber identify card, memory card in formats of SD, miniSD, microSD, and SDHC, different USB formats, and other communication interfaces.

Antenna logic 340 may communicate wirelessly with a wireless extension device 360 using wireless protocols such as Bluetooth, IEEE 802 formats, near field communication (NFC), wireless SUB, ZigBee, Wi-Fi, and other wireless formats. Interface device 100 may include any number of wired and wireless communication interfaces. For example, an interface device may include at least two wired extension device interfaces, a SIM interface, Bluetooth interface logic, and NFC interface logic.

One of more antennas within antenna logic 340 can be implemented as a passive antenna, an active antenna, or a combination. When implemented as a combination of antennas, the passive antenna draws no current until a frequency-sensing component within antenna logic 340 detects the presence of a relevant communication modality. Upon detection of a relevant communication modality, the passive antenna transmits a signal that turns on an active antenna configured to receive signals in the relevant communication modality, for example Bluetooth, NFC, or some other wireless protocol. Such a capability for low-power monitoring of a communication modality that, once activated, exacts higher power requirements can be very useful in conserving power and maximizing utility of interface device 100.

Though described as separate interfaces, input/output (I/O) interface 320 and 325, SIM interface 330, and antenna logic 340 can be considered embodiments of an extension device interface.

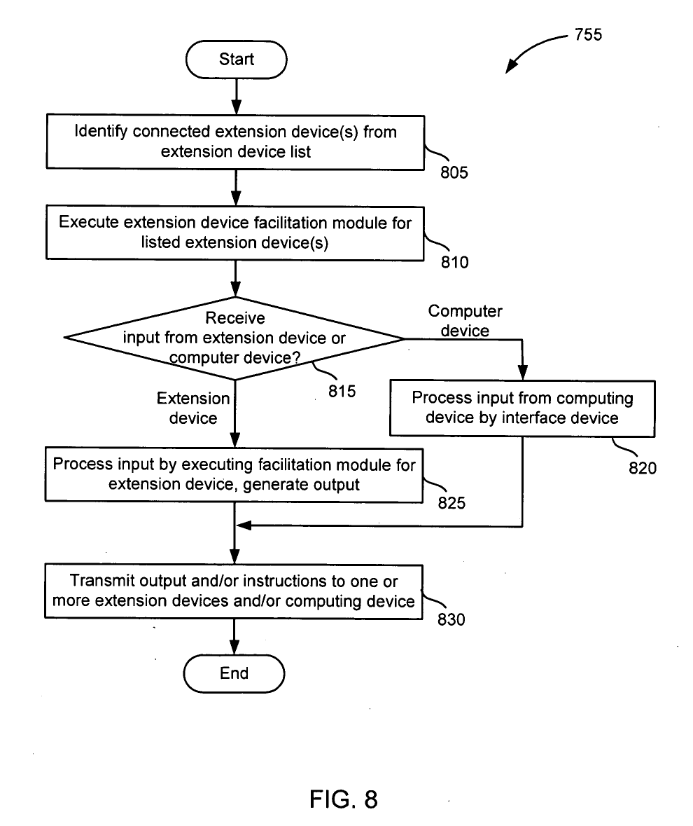

Interface device 100 further includes memory 345 for storing data and instructions, including extension device facilitation modules 350 and look-up table 355. Memory 345 can include flash memory, RAM, ROM, one or more cache configurations, and other storage logic. Look-up table 355 may include a list of extension devices that are compatible with interface device 345 and information for an extension device facilitation module 350 corresponding to each extension device. The extension device facilitation modules 350 may include software, such as drivers, protocol information, interface programs, applications, and other instructions and data that may be used to control and communicate with an extension device. When an extension device is connected, an extension device facilitation module 350 associated with the connected extension device is executed to facilitate control and communications for the extension device. Facilitating communication with extension devices is discussed in more detail below with respect to FIG. 8

FIG. 4 illustrates a block diagram of an exemplary controller 310. Controller 310 comprises a plurality of modules for controlling interface device 100 and for facilitating communication between extension modules and computer devices connected to the interface device. In an exemplary embodiment, controller 140 comprises communication module 405, authentication module 410, processor module 415, external device management modules 415, security management module 425, and power management module 430. Each of modules 405-430 may be implemented by any combination of software and hardware and communicate over one or more data buses 440.

Communication module 405 is configured to control wired and wireless communications between interface device 100, extension devices, computing devices, and other interface devices. When configuring communications with external devices, communication module 405 can configure transmission of data through one or more device interfaces and route received data to the appropriate internal component or external component.

Authentication module 410 can authenticate connected extension devices, interface devices, computer devices, and other devices. In some embodiments, authentication module 410 may receive connection request and identification data from a connected device. Authentication module 410 may then determine the authenticity of the connected device and either accept or deny the connection request. In some embodiments, authentication module 410 may authenticate a connected device by determining if the identification data matches a list of approved devices.

Upon a connection between interface device 100 and a computing device, or upon a connection between interface device 100 and an extension device, authentication module 410 instructs communication module 405 and security module 430 to securely query the identity of the connecting device. Authentication module 405 receives the identification query response from communication module 405 and compares the response data with information stored in memory 345. Authentication module then transmits an authentication signal to communication module 405 to indicate if the device was successfully authenticated. If the authentication failed, the device is ignored by communication module 405. If authentication was successful, communication module 405 manages communication with the device.

In some embodiments, authentication module 420 may perform permission functions. For example, authentication module 410 can evaluate one or more conditions or parameters to determine access to resources or functionality of interface device 100 or an extension device. Authentication module 410 can provide access to different portions of memory in the device upon receiving a registration number that matches a stored registration number, or may enable a feature in an extension device based on user identification data received through a second extension device, such as a smart card or fingerprint recognition device. For example, interface module 420 may enable or disable the availability to the computing device 310 of one or more functions of an extension device, may enable or disable access to a portion of a memory/storage module 640, may enable or disable a specific functionality of a port or an extension device, and may enable or disable a specific functionality based on receiving a pass code, receiving biometric information, detecting the presence of a hardware device (e.g., a specific extension device), receiving a security token, and so forth. In some embodiments, authentication module 410 can communicate with security module 430 to secure access to interface device 100, an extension device, or some other device.

Processor module 415 can receive and process data, generate instructions, and transmit the data and instructions to communication module 405 for transmission to the appropriate device or module. Processor module may include one or more general processors, one or more specialized processors, or other processing circuitry for processing data and communicating with other modules of controller 310.

Extension Device Management module 420 manages extension devices, cards, and computer devices, connected as external components to interface device 100. Extension Device Management module 420 may detect wired connections or wireless connection requests from extension devices (as well as cards and computing devices) and identify the extension device. Extension device identification can be performed by Extension Device Management module 420 using stored information or information received from the extension device. Module 420 may then retrieve an extension device facilitation module for identified extension modules and provide protocol data for the identified extension device to communication module 405.

Power module 430 may include logic to control power to interface device 100 and one or more extension devices. Power module 430 may comprise a battery or another device, e.g., capacitor, electromechanical, or electrochemical source. Power module 430 may be configured to generate or to store power, as well as recharge a rechargeable batter or other power source. Power module 430 may communicate and/or control power management control logic 315 to mange power for interface device 100.

Security module 430 provides for secure communication between interface device 100 and an external device, such as an extension device or computing device. Secure communication can be achieved by encryption and decryption techniques, security tokens, certificates, secured passwords, access lists, and other security mechanisms. The security mechanisms may be used to communications provided by communication module 405, communications received from an external device, or other communications received or transmitted by interface device 100.

In some embodiments, security module 430 may generate security tokens using data obtained from a wired connection with an extension device. For example, interface device 100, configured with a SIM card, may form a hard or wired connection with an interface device having a SIM Card. During the hard connection, interface device 100 and the extension device may exchange SIM card data. Matching security tokens can then be generated using data for each SIM Card, which both the interface device 300 and extension device both have access to after the data exchange. After generating the security tokens, the interface device and extension card can then communicate in a secure manner by encrypting and decrypting communications using the matching security tokens. The security tokens can be used for establishing secure wireless or wired communication.

FIG. 5 illustrates an example of interconnected interface devices. The system of FIG. 3 includes interface device 100, interface device 150 and computing device 510. Interface device 100 includes a plug 110 and receptacle 130 and interface device 150 includes a plug 160 and a receptacle 170. Computing device 510 includes a port or receptacle 520. In some embodiments, each plug and receptacle of the interface devices 100 and 150 and computing device 510 may conform to the same interface standard, such as USB interface or some other interface. In some embodiments, the plugs and receptacles can have different interface standards.

The interface devices 100 and 150 may connect together to form a compound interface device. Plug 110 is configured to electrically and mechanically connect interface device 100 to computing device 510 via receptacle 520. Second receptacle 130 is configured to receive plug 160 of interface device 150 to form an electrical and mechanical connection between interface devices 100 and 150. Any of several interface standards can be used to implement the plugs and receptacles between interface devices 100, 150 and computing device 510, for example USB 1.0, USB 2.0, USB 3.0, Ethernet, Firewire type interfaces, PS-2, optical connection, 2 mm, D-subminiature (D-sub), future bus, SubMiniature Version A (SMA), Peripheral Component Interconnect Express (PCI Express), and others.

When two or more interface devices are connected, the devices form a compound interface device and may operate as a single device. For example, an extension device connected to any interconnected interface device may communicate with extension devices connected to other interface devices comprising the compound device.

Though the computing device 510 in FIG. 5 is illustrated as a laptop computer, computing device 510 suitable for connection with interface device 100 may include a personal computer, notebook computer, desktop computer, mobile device, cellular phone, personal digital assistant, and other computing devices.

FIG. 6 illustrates an example of an interface device connected to extension devices. The system of FIG. 6 includes computing device 510, interface device 100, first extension device 610 and second extension device 620. In the exemplary embodiment illustrated, first extension device 620 can be implemented as a GPS device and second extension device 610 can be implemented an LCD display device. Interface device 100 comprises an interface plug 110 that is configured to be received by receptacle 520 of computing device 510 and extension device interfaces (receptacles) 140 configured to receive plugs of extension devices 610 and 620.

Interface device interface (140) receives plug 615 of the LCD extension device 620. Another interface device interface (not illustrated) receives plug 625 of the GPS extension device 610. The interface device and extension devices form an electrical and mechanical connection through the interface device interfaces and plugs 625 and 615. In some embodiments, the extension devices can be connected to interface device 100 in series rather than through separate interfaces, as illustrated in FIG. 6. Whether extension devices are connected in series or otherwise, interface device 100, interface device 100 can facilitate communication between the computing devices as well as with computing device 510. Thus, computing device 510 will “see” chained extension devices 620 as indistinguishable from a compound component.

Extension devices connected to the interface device 100 can implement various features, such as mass storage devices, either secure or unsecure (for example, an SD/microSD device), security devices (for example, a fingerprint scanner, or other biometric security device, SIM card reader), communication devices (for example, a Bluetooth, NFC, or ZigBee extension device), service devices (for example, a global positioning system [GPS] device), input devices (for example, a keyboard), or output devices (for example a liquid crystal display [LCD] device).

In some embodiments, the extension device can include a smart chip extension device. A smart chip is a secured computing element widely known in the art and used for a variety of different applications, including subscriber identity modules (SIMs) for GSM-based mobile phones and in credit cards. A smart chip extension device is an electrical component capable of communicating with smart chips and reading information from them. Some smart chip extension devices are also capable of writing information onto smart chips.

In some embodiments, the extension device can include a fingerprint data acquisition device, or fingerprint device. A fingerprint device is a computing element used in identity verification applications. It is capable of capturing biometric information from human fingertips securely and encoding it in a fashion suitable for biometric identification and verification purposes.

In some embodiments, the extension device is an adapter for mass storage media, such as a microSD memory card. A microSD is a non-volatile memory card format used in electronic devices that can be used for storing a variety of digital content, with or without embedded digital rights management (DRM) functionality. The system can therefore be used as an external mass storage device for storing a variety of digital data, including digital media with embedded DRM functionality.

In some embodiments, the extension device is a wireless communication device that supports a short-distance communication protocol based on radio waves, including NFC technology, RFID (Radio Frequency Identification) technology, ZigBee (IEEE 802.15.4) technology, Bluetooth technology wireless USB technology, or other technologies. In some embodiments, the extension device is a service device, such as a Global Positioning System (GPS) extension device capable of providing positioning information to the computing device.

Embodiments of the interface device support multiple and simultaneous extension device connections. Functionality of the extension devices can thereby be extended by utilizing the several connected extension devices. For example, an extension device with two simultaneously connected secure chip readers can be used for copying information on-the-fly from one secure chip to another. Alternatively, the extension device can be used in security applications that require holding two independent secure tokens.

Other combinations of the interface device with various extension devices will be apparent to those skilled in the art. For example, embodiments of the interface device that combine extension devices may be useful for one or more of the security market, the mobile telecommunications market, the financial market, and other markets include a combination of the interface device with a smart chip device and an additional mass storage device such as a microSD mass storage card, a combination of the interface device with a smart chip device and a fingerprint device, a combination of the interface device with a secure token storage device and a smart chip reader, a combination of the interface device with a secure token storage device, a smart chip reader and an additional mass storage device (such as microSD), a combination of the interface device with dual smart chip devices and with a contactless communication device, a combination of the interface device with dual smart chip devices, a combination of the interface device with dual smart chip devices, and a Bluetooth interface device, a combination of the interface device with dual smart chip devices, a Bluetooth interface device, and a GPS device.

In yet another embodiment of the interface device, the combined components are used in such a way as to complement functionality of one another. For example, combining security token functionality with biometric functionality of an extension device can result in a security system where the security is not tied to a physical device but to a person who needs to unlock the device using a biometric property unique to himself or herself. In such an embodiment, the security token functionality can be activated for a limited amount of time when a fingerprint-reading extension device recognizes a pre-defined biometric fingerprint property of the user.

In some embodiments, extension devices can be connected to interface device 100 in series. In this configuration, the outer extension device will communicate its functionality to the next extension device, which may communicate the functionality of itself and the outer extension device to the next extension device, and so forth, until the functionality of the entire series of extension devices is communicated to the extension devices. In some embodiments, one or more extension devices can be connected to any port of the interface device, including an NFC, Bluetooth, USB port, or other port.

In some embodiments, the portable interface device can emulate one or more devices connected to the interface device. For example, a first extension device can be connected to a computing device and at least one extension device and/or at least one additional interface device, each device associated with it's own functionality. The first extension device can communicate with the computing device as one device with a set of available functions rather than a set of devices each having their own functionality. As such, the computing device only detects a single interface device rather than a first interface device, one or more extension devices and and/or at least on additional interface device.

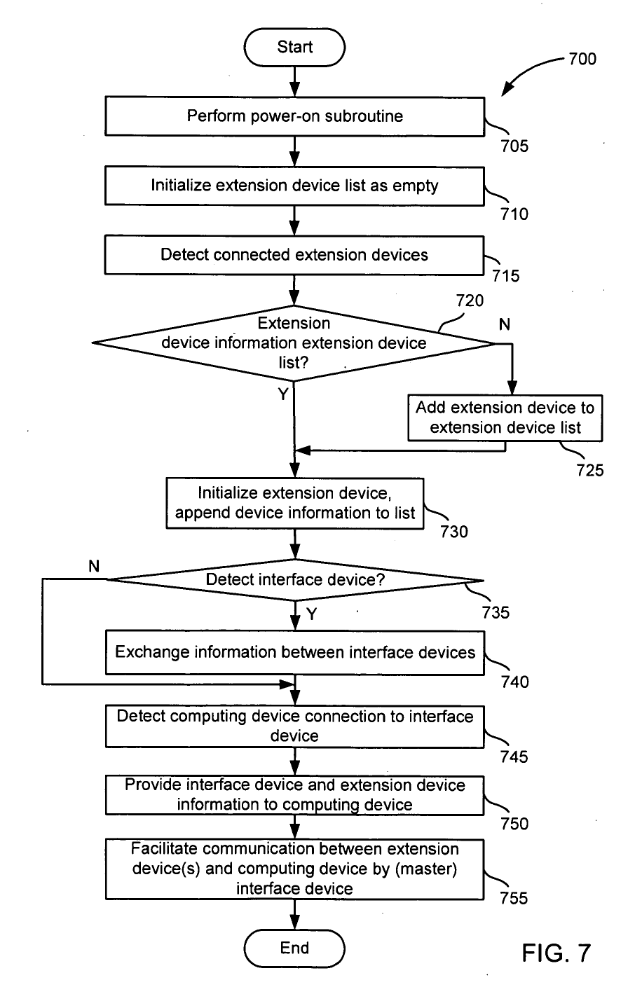

FIG. 7 illustrates a flow chart of an exemplary method of operation for an interface device 100. First, a power-on subroutine is performed at step 705. The power-on subroutine may be performed in response to detecting a connection to a computing device, a switch is manipulated that applies power to the device, or the system otherwise receives power. An extension device list is initialized as empty at step 710. The extension device list can be stored in memory 345. The interface device 100 then detects any connected extension device at step 715. In some embodiments, the interface device 100 determines whether the detected extension device is active, for example by sending a query signal to the extension device.

A determination is then made as to whether the detected device is already present on the extension device list at step 720. If the extension device is not already on the list, the extension device is added to the extension device list at step 725 and the method continues to step 730. If the extension device is contained on the list, the extension device is initialized and information about the extension device is appended to the list of extension devices at step 730.

A determination is made at step 735 as to whether an interface device is detected at step. In some embodiments, multiple interface devices may be connected together as illustrated in FIG. 5. If an interface device is connected, information for the interface device is exchanged by the interface devices and stored at step 740. In some embodiments, the information includes which interface device is the base device. For example, an interface device may be selected to be a base interface device if it receives a plug of another interface device, is connected to a computing device, or meets some other condition. In some embodiments, the information includes extension device information for each interface device.

A computing device may be detected at step 745. The interface device and extension device information is provided to the computing device at step 750. The extension device information transmitted to the computing device may include availability and functionality information for the extension devices. Communication between the extension device(s) and computer device is then facilitated by the interface device at step 755. Facilitating communication between the extension device and computing device is discussed in more detail below with respect to the method of FIG. 8.

For all extension devices that are subsequently removed from the interface device, information about the removed extension device is removed from the list. The interface device communicates to the computing device information about the removed extension device so that this event can be handled appropriately by the computing device. Portions of the method of FIG. 7 can be repeated for the addition of additional extension devices, computing devices and interface devices.

FIG. 8 illustrates a flow chart of an exemplary method for facilitating communication by an interface device. In some embodiments, the method of FIG. 8 provides more detail for step 755 of the method of FIG. 7. First, extension devices from the extension device list are identified at step 805. Extension device facilitation modules are executed for each extension device at step 810. In some embodiments, executing extension device facilitation modules is performed during initialization of the extension device at step 730 in the method of FIG. 3. In some embodiments, controller 310 handles communications between extension devices rather than extension device facilitation modules, and no modules or code are required to be executed in order to communicate with the extension modules.

Input is received by the interface device at step 815. If the input is received from a computing device, the input is processed by interface device at step 820 and the method continues to step 830. If the input is received from an extension device, the extension device facilitation module corresponding to the extension device processes the input. In some embodiments, controller 310 may process the received input.

After processing the input, an output or result is generated and the output or instructions based on the output are transmitted at step 830. The output can be transmitted to a computing device, one or more extension devices, a connected interface device, or a combination of these devices. For example, the output may report the processed results to the computing device, instruct an extension device to perform an operation, stored locally, or reported in some other way.

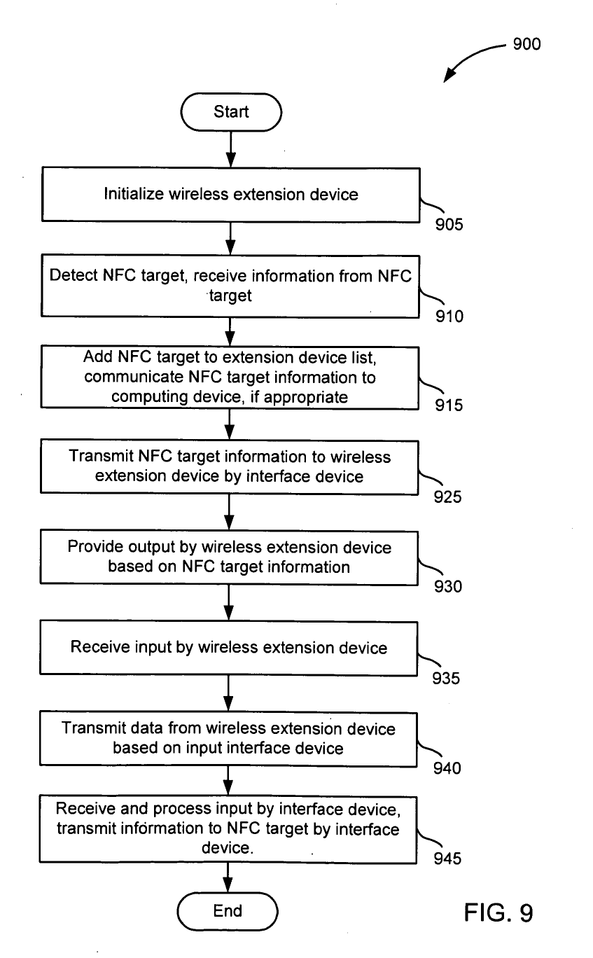

In some embodiments, communication between one or more extension devices may include wireless communication. For example, an interface device can be configured to facilitate communication between a wireless device such as a mobile device and an NFC target. In some embodiments, the wireless device does not have the capability of communicating using NFC protocol. FIG. 9 illustrates a flow chart of an exemplary method for facilitating communication between a wireless extension device and an NFC target. Steps 905-920 relate to an embodiment of steps 715-730 of the method of FIG. 7 and steps 925-945 relate to an embodiment of steps 815-830 of the method of FIG. 8.

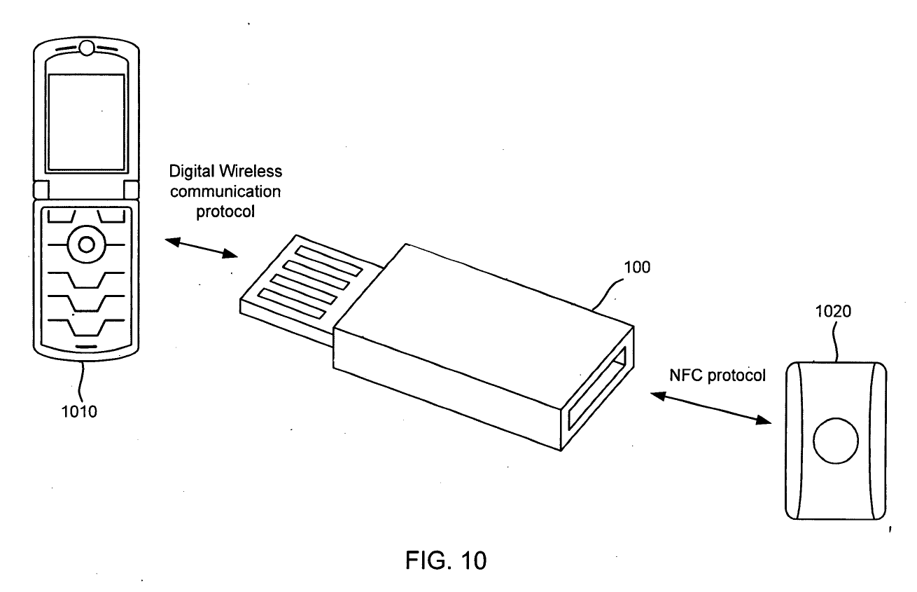

First, a wireless extension device is detected and initialized at step 905. An embodiment of an interface device that communicates with wireless extension devices is illustrated in FIG. 10. FIG. 10 includes interface device 100, cellular phone 1010 and NFC target 1020. With respect to FIG. 10, the wireless extension device, or cellular phone, is detected by interface device 100 through a digital wireless communication protocol, such as Bluetooth protocol. Once detected, the wireless device is initialized and information for the wireless device is added to the extension device list.

An NFC target can be detected at step 910. The target can be detected through any NFC communication protocol, including the use of active or passive RFID communication. Information for the detected NFC target is received by interface device 100 through a wireless NFC communication link. After detecting and receiving information from the NFC target, the NFC target is added to the extension device list at step 915. In some embodiments, information for the NFC target is communicated to a computing device, if applicable.

The NFC target information is transmitted to the wireless extension device by the interface device at step 925. In some embodiments, the NFC target information is transmitted by the interface device to the wireless device using Bluetooth wireless communication protocol. The wireless device receives the NFC target information from the interface device and outputs the information at step 930. In some embodiments, the NFC target information can be output through a display device of wireless extension device, such as a cellular phone display.

Input may be received by wireless extension device at step 935. The input may indicate information to transmit back to the NFC target. For example, the input received by the wireless extension device may indicate that a payment should be made, that information for a smart poster should be retrieved, or that some other instruction or query should be transmitted to the NFC target. Data based on the input received by wireless extension device is transmitted to interface device 100 at step 940. Interface device 100 may receive the input data, process the input and transmit instructions or other data to the NFC target at step 945. In some embodiments, the data or instructions transmitted to NFC target at step 945 may indicate payment instructions, user information, account information, or other data required to perform a payment. Steps 920-945 can be repeated to further facilitate communication between the NFC target and wireless device, such as those illustrated in FIG. 10, using interface device 100.

As discussed above with respect to FIGS. 9-10, an extension device may communicate with an interface device using NFC wireless protocol. An NFC extension device can be used for a variety of applications requiring active or passive communication over a short distance, for example in secure payment transactions. Other wireless extension devices may utilize other wireless protocols, including RFID, Bluetooth, ZigBee, and other protocols. RFID technology can be used for a variety of other applications requiring passive communication over a short distance, for example in identification applications, authentication applications, or other applications. Bluetooth-enabled extension devices can be used for secure communication with other electronic devices or for other applications. ZigBee-enabled extension devices can be used for establishing wireless area networks with other electronic devices or for other applications.

NFC is a short-range communication technology that enables wireless data transfer between two electronic devices within a typical range of several inches. To initiate communication with an NFC target, a user brings an NFC-enabled device, such as interface device 100, in proximity of the NFC target. In some implementations of NFC technology, the NFC-enabled device must come in contact with another NFC-enabled device to initiate data exchange.

Embodiments of the present technology provide an interface device that functions as an NFC reader and writer (NFC unit) as a payment utility capable of implementing an active payment instrument and an NFC enabled trusted POS terminal. The active payment instrument can initiate NFC payment transactions when used in conjunction with NFC enabled POS terminals in retail or other environment. The NFC enabled trusted POS terminal embodiment can initiate NFC payment transactions when used in conjunction with NFC enabled payment cards in a consumer's home.

For example, a customer can interact with a movie poster or other billiard advertisement with an NFC chip in it. The customer can activate a set of options by tapping his phone or his NFC interface device on the poster. The set of options will then be eventually communicated to and displayed an output extension device 330 (such as a mobile device), the interface device or extension device. For example, options can include displaying different movie possibilities, downloading one or more trailers directly from the chip, streaming video taken from one or more movies of interest, displaying theaters showing one or more movie, displaying directions to these theaters from the current location, displaying other features of interest that are located near these theaters and/or en route to these theaters from the customer's current location, and buying one or more tickets to the movie. Tickets can be purchased through appropriate input to one or more of user input 770 and/or tapping the phone or NFC interface device on the poster at appropriate times based on the instructions provided on output device 330 (not pictured). The tickets and/or a digital receipt can optionally be downloaded to interface device 100. Optionally, tickets purchased can be detected remotely as the customer enters the theater with interface device 100, with no requirement that the customer show a ticket to an usher.

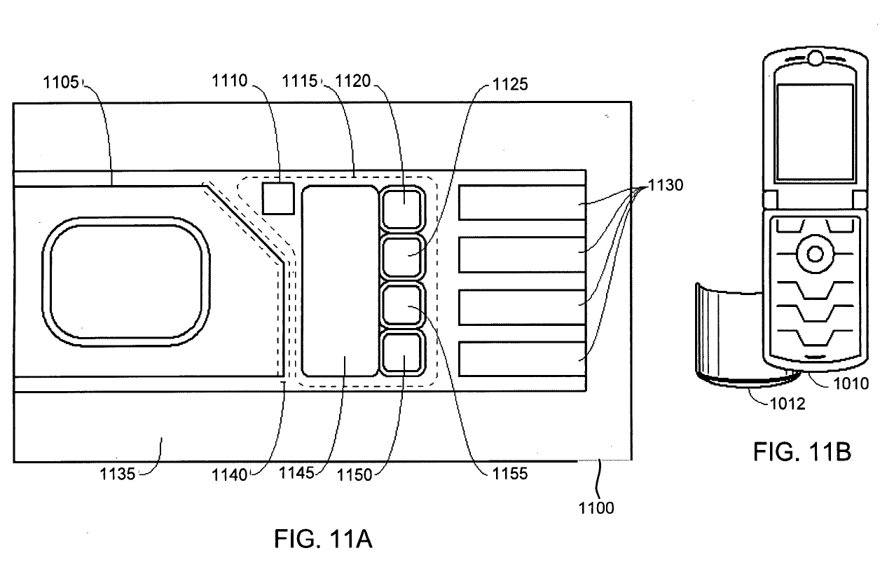

FIG. 11A illustrates an exemplary NFC payment interface device for facilitating wireless communication and wireless payment. NFC payment interface device 1100 comprises an optional adhesive panel 1135, SIM securing mechanism 1140, USB contacts 1130, power module 1145, and circuitry elements 1120, 1125, 1155 and 1150. The exemplary NFC payment interface device may be attached to a cellular phone 1010 (FIG. 11B), for example by attaching the device to a battery cover 1012 or replacing the battery cover.

In some embodiments, the NFC payment interface device 1100 may be attached to cellular phone 1010 by an adhesive. For example, optional adhesive panel 1135 can be used to affix the NFC payment interface device 1100 to cellular phone battery cover 1012 in FIG. 11B. Adhesive panel 1135 is optionally separable from the rest of NFC payment interface device 1100. In some embodiments, the NFC payment interface device can be attached to a spring-loaded bay 1140 comprising contacts adapted to provide power to and to interchange data with a removable SIM card 1105, male USB contacts 850, and a controller 140. In some embodiments, NFC payment interface device can be positioned inside a battery cover of cellular phone 310 (or other mobile device), for example by adhesive panel 1135. In some embodiments, NFC payment interface device can be positioned to the outside of a battery cover of a mobile device, outside the battery itself, or in some other position on the outside of a battery cover.

In some embodiments, interface device 1100 can be mechanically connected to a cellular phone 1010 or other computing device 310. For example, the NFC payment interface device can be connected to a cellular phone casing to replace a cellular battery cover housing 820 for a cellular phone 310, or connected/affixed in some other manner. NFC payment interface device optionally comprises mechanical sliding rails adapted to hold NFC payment interface device 1100 firmly in place adjacent to cellular phone 310.

The circuitry elements of the NFC payment interface device may include one or more elements that comprise interface device 100 discussed with respect to FIG. 3 and controller 310 discussed with respect to FIG. 4. For example, a controller implemented on NFC payment interface device may comprise USB controller 1120, first wireless modality controller 1125, second wireless modality controller 1155, memory/storage module 1150 and power module 1145. In exemplary embodiments, first wireless modality implements NFC protocol communication (to communicate with an NFC target) and the second wireless modality implements Bluetooth protocol communication (to communicate with Bluetooth logic in cellular phone 1010). An NFC payment interface device controller may also include an on-board data processing module 1110, which can be implemented at least in part by SIM card 1105.

NFC payment interface device may also include a security module to ensure secure operation of interface device 1100 and secure communication with other devices. In some embodiments, the security functionality can be executed at least in party by SIM card 1105.

Power module 1145 can include a removable rechargeable battery 1145. Rechargeable battery 1145 can be removed from NFC payment interface device 1100, recharged, and reinserted in NFC payment interface device 1100 as needed. In some embodiments, the interface device is fully self-contained and includes a rechargeable battery. The interface device can be detachable from the battery cover of the computing device to facilitate battery recharging. In some embodiments, the NFC payment interface device is affixed to the back side of the battery cover and contains two conductors attachable to the leads of the cellular phone battery. In this configuration, the battery does not require being recharged, but rather draws power from the computing device battery/power source.

In some embodiments, as discussed above, the NFC payment interface device may include a passive antenna and an active antenna. The passive antenna is powered on when the antenna is positioned in close proximity of an NFC target's electromagnetic field. When the passive antenna is powered in, a signal is generated which triggers power to be supplied to the active antenna. Using this dual antenna system, the active antenna need not use power unless a target for communication is detected.

In some embodiments, a single antenna for use with wireless communication is used for data communication as well as detecting electromagnetic fields. For example, the same Bluetooth antenna can be configured to transmit and receive the Bluetooth wireless data signals between a cellular phone and the NFC payment interface device, as well as for detecting an electromagnetic field from the cellular phone to power up a Bluetooth adapter.

In some embodiments, the NFC payment interface device may utilize a software switch for activating or deactivating NFC and/or RFID circuits on the NFC payment interface device. By controlling when the NFC payment interface device is activated, the interface device cannot be used until a user “turns it on” using the switch. In some embodiments, activating the switch may include providing instructions to the cellular phone in communication with the interface device, pressing a button the interface device, or performing some other task or action.

In some embodiments, the NFC payment interface device may utilize one or more switches implemented at least in part by hardware. For example, a hardware switch can create an open connection (i.e., a break in the connection) between a smart chip and an antenna in the NFC payment interface device. A hardware switch may also short circuit the antenna. In some embodiments, a hardware switch can turn off the main NFC/RFID antenna and turn on a decoy RFID antenna. Hence, the NFC payment device can have a protected antenna and a public antenna. The protected antenna is used for payments and is switched on by the user when a payment or other transaction is performed. The public antenna is a decoy mechanism that can be detected by external devices but will not provide useful data to the external devices. Instead of providing useful data, the public antenna may provide incorrect or otherwise useless data. In some embodiments, the hardware switch may turn off the NFC antenna by cutting power to the device, thereby preventing the NFC antenna from operating. In some embodiments, any of these hardware switches may be controlled by a software interface implemented by the attached computing device.

As discussed above, interface device security can be improved by establishing a hard connection “handshake” between cellular phone extension device and interface device 1100. Such a hard connection can be made, for example, by inserting both a cellular phone and interface device 1100 into USB ports of a personal computer, by inserting both cellular phone and interface device 1100 into USB ports of a “dummy” interface device, or by other methods, or connecting the cellular phone and interface device 1100 to each other. When connected, the cellular phone and interface device 1100 can exchange information typically not transmitted over a wireless connection, such as private data on a SIM card within each device.

In some embodiments, the NFC interface payment device can provide secure communications using the POS terminal of the device. NFC communication functionality of the device can be enabled by sending a special security key to the device before an NFC/RFID transaction is performed. Generation of the security key can be implemented by additional circuitry, for example circuitry outside the NFC logic of the device. The security can be managed by a remote platform that provides a required unlock key only to specific POS terminals on the device.

In some embodiments, NFC payment interface device 1100 can be configured as a payment terminal. In this embodiment, the device can be securely used in an insecure environment, such as when interface device 1100 is used in conjunction with a personal computer comprising a modem or other wireless communication device connected to the Internet. The NFC payment interface device 1100 can be connected to a computing device. When a consumer needs to start a payment transaction with an NFC-enabled or otherwise wireless-enabled third-party payment 330, such as payment for goods ordered over the Internet or during an online banking session, a consumer can use interface device 1100 as a payment terminal. Information sent from a third-party payment device will be received by interface device 1100 and encrypted. Alternatively, the transaction does not require an external NFC-enabled payment instrument, and instead all account information can be obtained from an internal secure memory/storage module of the NFC interface device.

In another embodiment, an NFC payment interface device stores several different payment accounts. Software applications running on the consumer's personal computer manage the account information in such a way that a consumer can add payment accounts to the NFC payment interface device or remove account information from the payment interface device.

To add an account to the payment interface device, the software application connects to a service provider (such as bank or a payment processor) over a network and requests account information, which is encrypted and sent back to the consumer and further downloaded into an NFC payment interface device. Security is provided by using PKI, whereby each NFC payment interface device has its own securely generated PKI key pair and a trust certificate. As a result, unencrypted information is never exposed outside of an NFC payment interface device.

In another embodiment, a consumer connects an NFC payment interface device to his personal computer to perform a payment transaction over the Internet. If the consumer has any payment accounts stored on the NFC payment interface device, these accounts can be used. Alternatively, the consumer can use other NFC/RFID enabled payment instruments while using the payment-enabled NFC payment interface device as a proximity-based payment terminal by bringing them together and tapping one on the other. The payment transaction will be transmitted securely between the NFC payment interface device and the online merchant and all encryption/decryption will be handled by the NFC payment interface device.

In some embodiments, some specific functions of the interface device may be disabled (i.e., locked) until the interface device or an extension device is upgraded, e.g., by payment of a specified amount of money, entry of a pass code, presence of a security token, presence of a specific extension device, etc. For example, additional memory can be unlocked by payment of a fee to the manufacturer. The manufacturer of the extension device and the user then both benefit by saving expense and trouble with faster upgrades. A similar feature can exist on the interface device as well. For example, an extension device may include a secure token functionality, pre-built into the extension device; however the supplier of the extension device determined that the additional functionality should be disabled. Once a user decides to upgrade the extension device to include additional functionality, instead of replacing its hardware a secure token can be send to the extension device that unlocks the specific functionality and makes it available for the user. This creates an opportunity for saving manufacturing costs while increasing service revenue for the vendor of the extension device.

The present technology is described above with reference to exemplary embodiments. It will be apparent to those skilled in the art that various modifications may be made and other embodiments may be used without departing from the broader scope of the present technology. Alternative embodiments may contemplate utilizing more extension devices. Therefore, these and other variations of the exemplary embodiments are intended to be covered by the present technology.

What is claimed is:

1. A portable interface device for extending the functionality of a computing device, comprising:
a first communication interface configured to facilitate communication between the computing device and the portable interface device;
a second communication interface configured to facilitate secure communication between the portable interface device and a first extension device; and
a controller configured to enable the computing device to access functionality of the extension device.

2. The portable interface device of claim 1, wherein the portable interface device further includes security logic for implementing secure transactions.

3. The portable interface device of claim 1, wherein the security logic interfaces with a smart chip for establishing secure communications.

4. The portable interface device of claim 1, wherein the smart chip is external to the portable interface device.

5. The portable interface device of claim 1, wherein the smart chip is incorporated internally within the portable interface device.

6. The portable interface device of claim 1, wherein at least one of the communication interfaces is a wireless interface.

7. The portable interface device of claim 6, wherein the portable interface device further includes an antenna.

8. The portable interface device of claim 7, wherein the first communication interface implements a control protocol and the second communication interface implements a transaction communication protocol.

9. The portable interface device of claim 8, the control protocol configured to communicate control signals with a mobile device.

10. The portable interface device of claim 1, wherein the interface device is configured to facilitate communication between the first extension device and a second extension device.

11. The portable interface device of claim 1, wherein the interface device emulates the first extension device.

12. The portable interface device of claim 1, further comprising a casing which contains the first communication interface, the second communication interface, and the controller,
the casing having a length greater than a width, the casing further having a length-wise measured perimeter of about nine inches or less.

13. A portable interface device for extending computing functionality, comprising:
a casing,
a plurality of interfaces configured to facilitate communication with a computing device and an extension device by the portable interface device, the plurality of interfaces coupled to the casing; and
a controller providing functionality access between the computing device and the extension device through the plurality of ports, the controller coupled to the casing.

14. The device of claim 13, wherein the plurality of interfaces includes a Universal Serial Bus interface.

15. The device of claim 13, wherein the portable interface device is configured to attach and detach from a computing device using the Universal Serial Bus interface.

16. The device of claim 13, the portable interface device further comprising logic for securely communicating through the plurality of ports.

17. The device of claim 13, the portable interface device further comprising logic for authenticating access to a resource.

18. The device of claim 13, the portable interface device further comprising a battery.

19. The device of claim 13, the plurality of interfaces including two or more wireless interfaces for communicating with wireless devices.

20. A portable interface device for securely extending computing functionality, comprising:
one or more antennas for communicating with a first wireless device and a second wireless device;
interface logic for connecting to a first wireless device and a second wireless device using the one or more antennas;
security logic for facilitating secure communication with the first wireless device and the second wireless device; and
a controller for managing communication between the portable interface device and each of the first wireless device and the second wireless device,
the portable interface device communicating with the second wireless device using near Field Communication Protocol, the portable interface device communicating with the first wireless device using a wireless protocol other than near field communication protocol.

21. The portable interface device of claim 20, of claim wherein the first wireless device is a mobile device that does not communicate using Near Field Communication protocol.

22. The portable interface device of claim 20, further comprising an attachment mechanism for attaching to the first wireless device.

23. The portable interface device of claim 22, wherein the attachment mechanism is an adhesive element.

24. The portable interface device of claim 23, wherein the adhesive element is configured to attach inside a battery cover of a mobile phone.

25. The portable interface device of claim 23, wherein the adhesive element is configured to attach to an outer surface of a battery cover of a mobile phone.

26. The portable interface device of claim 22, wherein the attachment mechanism is configured to replace a battery cover for the mobile device.

27. The portable interface device of claim 20, further comprising a rechargeable power source.

28. The portable interface device of claim 20, wherein the interface logic implements a near field communication (NFC) interface,
the controller configured to manage payment transactions using the NFC interface.

29. The portable interface device of claim 20, wherein the second wireless device is an NFC target.

30. The portable interface device of claim 20, wherein the one or more antennas include a passive antenna.

31. The portable interface device of claim 20, wherein the one or more antennas include an active antenna, the interface logic configured to activate the active antenna upon detection of an electromagnetic field through the passive antenna.

32. The portable interface device of claim 20, further comprising a mechanism for receiving a SIM card.

33. The portable interface device of claim 32, wherein security logic achieves secure communication at least in part using data from a SIM card connected through the mechanism for receiving the SIM card.

34. The portable interface device of claim 20, wherein the interface logic implements a switch for providing power to the one or more antennas.

35. A method for facilitating extended functionality by a portable interface device, comprising:
initializing one or more extension devices detected by a portable interface device through one or more interfaces;
receiving input from a first extension device;
processing the input by the portable extension device; and
providing output to a second device, the output derived from the processed input.

36. The method of claim 35, further comprising establishing a connection with a computing device by the portable extension device.

37. The method of claim 36, further comprising providing extension device information to a computing device by the portable extension device.

38. The method of claim 35, wherein the output is provided to a second extension device.

39. The method of claim 35, wherein the output is provided to a computing device.

40. The method of claim 35, further comprising:
receiving a first instruction from the computing device by the portable interface device; and
transmitting a second instruction to one or more extension devices by the portable interface device, the second instruction derived from the first instruction.

41. One or more processor readable storage devices having processor readable code embodied on said processor readable storage devices, said processor readable code for programming one or more processors to perform a method for facilitating extended functionality by a portable interface device, the method comprising
initializing one or more extension devices detected by a portable interface device;
receiving input from a first extension device;
processing the input by the portable extension device; and
providing output to a second device, the output derived from the processed input.

42. A system for extending the secure functionality of a computing device, comprising:
a computing device;
an extension device; and
a portable interface device for extending the secure functionality of a computing device,
the portable interface device being configured to facilitate secure communication between the computing device and the portable interface device, to facilitate secure communication between the portable interface device and an extension device; and to facilitate extended functionality between the computing device and the extension device, whereby the computing device can access functionality of the extension device.

43. A portable interface device for extending computing functionality, comprising:
one or more antennas for communicating with a first wireless device and a second wireless device;
interface logic for connecting to a first wireless device and a second wireless device using the one or more antennas;
a controller for managing communication between the portable interface device and each of the first wireless device and the second wireless device; and
a hardware switch that controls the operation of at least one of the one or more antennas,
the portable interface device communicating with the second wireless device using near Field Communication Protocol, the portable interface device communicating with the first wireless device using a wireless protocol other than near field communication protocol.

44. The portable interface device of claim 43, the hardware switch controlling a connection between a smart chip and the at least one antenna.

45. The portable interface device of claim 43, wherein the hardware switch is configured to short-circuit the antenna.

46. The portable interface device of claim 43, wherein the hardware switch is coupled to a protected antenna and a public antenna, the protected antenna configured for secure transactions and the public antenna configured for communications other than the secure transactions.

47. The portable interface device of claim 43, wherein the hardware switch controls power provided to the portable interface device.

48. The portable interface device of claim 43, wherein the hardware switch is controlled by code executing in the portable interface device.

49. The portable interface device of claim 43, wherein the hardware switch is controlled by signals received from an external device.
